(19) United States
(12) Patent Application Publication
(10) Pub. No.: US 2011/0100325 A1
(43) Pub. Date: May 5, 2011

(54) THREE-WAY THROTTLE VALVE

(75) Inventor: Shouhao Wu, Roselle, IL (US)

(73) Assignee: International Engine Intellectual Property Company, LLC, Warrenville, IL (US)

(21) Appl. No.: 12/610,499

(22) Filed: Nov. 2, 2009

(51) Int. Cl. F02D 9/08; F02M 25/07

(52) U.S. Cl. 123/337; 123/568.11

(57) ABSTRACT

A three-way throttle valve for an air intake system of an engine comprises an elongate-shaped valve plate, a positioning shaft, and an actuator. The elongate-shaped valve plate is disposed within an intake air portion of an air intake system. The elongate-shaped valve plate has a major axis and a minor axis. The positioning shaft connects to the elongate-shaped valve plate. The positioning shaft is disposed about the minor axis of the elongate-shaped valve plate. The actuator connects to the positioning shaft. The actuator has at least a first position setting, a second position setting, and a third position setting. At least a portion of the elongate-shaped valve plate contacts a portion of the intake air portion of the air intake system when the actuator is disposed in the first position setting.

### TECHNICAL FIELD

The present disclosure relates to an air intake system for a diesel engine having an exhaust gas recirculation (EGR) system, and more particularly to a three-way throttle valve for an air intake system for a diesel engine having an EGR system

### BACKGROUND

Many factors, including environmental responsibility efforts and modern environmental regulations on diesel engine exhaust emissions have reduced the allowable acceptable levels of certain pollutants that enter the atmosphere following the combustion of fossil fuels. Increasingly more stringent emission standards may require greater control over either or both the combustion of fuel and post combustion treatment of the exhaust. For example, the allowable levels of nitrogen oxides (NOx) and particulate matter have been greatly reduced over the last several years. To address, among other issues, environmental concerns, many diesel engines now have an exhaust gas recirculation (EGR) system that directs some exhaust gas from an exhaust system of the diesel engine into an air intake of the diesel engine. It has been found that higher levels of EGR may reduce NOx levels more effectively than lower levels of EGR. The EGR system provides EGR to the air intake system in a way that relies on a pressure difference between air in the air intake system and the EGR in the EGR system, as the air intake system typically has higher pressures than the EGR system. However, certain engine operating conditions exist when a pressure difference within the air intake system and the EGR system is not sufficient for high levels of EGR to enter the air intake system.

Therefore, a need exists for a throttle valve for mixing EGR from the EGR system with intake air in the air intake system to allow high levels of EGR to be provided to the engine under all operating conditions.

### SUMMARY

According to one embodiment, a three-way throttle valve for an air intake system of an engine comprises an elongate-shaped valve plate, a positioning shaft, and an actuator. The elongate-shaped valve plate is disposed within an intake air portion of an air intake system. The elongate-shaped valve plate has a major axis and a minor axis. The positioning shaft connects to the elongate-shaped valve plate. The positioning shaft is disposed about the minor axis of the elongate-shaped valve plate. The actuator connects to the positioning shaft. The actuator has at least a first position setting, a second position setting, and a third position setting. At least a portion of the elongate-shaped valve plate contacts a portion of the intake air portion of the air intake system when the actuator is disposed in the first position setting.

According to another embodiment, an air intake system of an engine comprises an intake air portion, a bypass portion, an EGR inlet and a three-way throttle valve. The intake air portion has a first connection point and a second connection point. The bypass portion connects to the intake air portion. The bypass portion connects at the first connection point and the second connection point to the intake air portion. The bypass portion has a reduced width region. The EGR inlet is disposed within the bypass portion. The three-way throttle valve is disposed within the intake air portion. The three-way throttle valve has at least a first position, a second position, and a third position. The first position of the three-way throttle valve directs fluid within the intake air portion to the bypass portion.

A method of controlling fluid flow within an air intake system of an engine having an intake air portion, a bypass portion, an EGR inlet, and a three-way valve is provided. Atmospheric air is provided into an intake air portion of the air intake system. An elongate-shaped three-way valve disposed within the intake air portion rotates to one of at least a first position, a second position, and a third position. The positioning of the elongate-shaped three-way valve directs the atmospheric air to at least one of the intake air portion and a bypass portion. Exhaust gas is provided into the bypass portion from the EGR inlet.

### BRIEF DESCRIPTION OF THE DRAWINGS

FIG. 1a is a functional diagram showing an air intake system having a three-way throttle valve to control flow of EGR into the air intake system with the three-way throttle valve in a first position;

FIG. 1b is a functional diagram showing an air intake system having a three-way throttle valve to control flow of EGR into the air intake system with the three-way throttle valve in a second position;

FIG. 1c is a functional diagram showing an air intake system having a three-way throttle valve to control flow of EGR into the air intake system with the three-way throttle valve in a third position; and

FIG. 2 is functional diagram showing the three-way throttle valve of FIG. 1.

### DETAILED DESCRIPTION

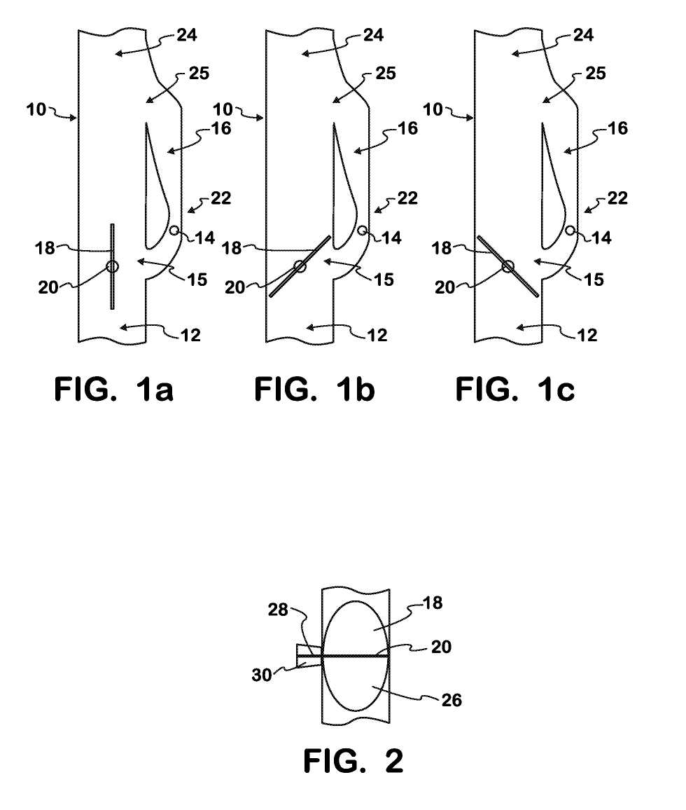

FIGS. 1a-1c depicts a portion of an air intake system 10. The air intake system 10 has an intake air portion 12 and an EGR inlet 14. The intake air portion 12 is adapted to contain atmospheric air. The atmospheric air within the intake air portion 12 may have passed through a turbocharger compressor and an intercooler prior to entering the intake air portion 12.

A bypass portion 16 connects to the intake air portion 12 at a first connection point 15 and allows fluid communication between the intake air portion 12 and the bypass portion 16 of the air intake system. The bypass portion 16 contains the EGR inlet 14. The EGR inlet 14 provides exhaust gas from an EGR system to the bypass portion 16. The exhaust gas provided to the EGR inlet 14 typically has a lower pressure than atmospheric air, particularly if atmospheric air has been compressed by the turbocharger compressor. A combustion air portion 24 of the air intake system 10 is disposed down stream of a second connection point 25 where the bypass portion 16 rejoins the intake air portion 12. The combustion air portion 24 contains a mixture of atmospheric air, and exhaust gas from the EGR system.

The bypass portion 16 forms a reduced width region 22 near the EGR inlet 14. The reduced width region 22 acts as a venturi under certain operating conditions such that a local low pressure region forms at a throat, or narrowest point, of the reduced width region.

A three-way throttle valve 18 is disposed within the intake air portion 12. The three-way throttle valve is disposed upstream of the connection point of the bypass portion 16 to the intake air portion 12. The three-way throttle valve 18 rotates about a rotation axis 20 such that the three-way throttle valve may be disposed into one of three general settings as shown in FIGS. 1a-1c.

As shown in FIG. 1a, the three-way throttle valve 18 is rotated about the rotation axis 20 such that the three-way throttle valve 18 is in a fully open position. The three-way throttle valve 18 is typically in a fully open position when an engine is operating at high speeds. When the three-way throttle valve 18 is in a fully open position, a majority of the atmospheric air passes through the intake air portion 12 and a portion of the atmospheric air passes through the bypass portion 16. Atmospheric air that diverts into the bypass portion 16 draws exhaust gas from the EGR inlet 14 near the reduced width region 22 of the bypass portion 16.

Atmospheric air and exhaust gas from the EGR inlet 14 within the bypass portion 16 rejoin atmospheric air from the intake air portion 12 at the second connection point 25 where the bypass portion connects to the intake air portion 12 in the mixed atmospheric air and Combustion air portion 24 of the air intake system 10. The mixed atmospheric air and exhaust gas from the mixed atmospheric air and Combustion air portion 24 is adapted to be delivered to at least one cylinder of the engine for use in combustion.

Turning now to FIG. 1b, the three-way throttle valve 18 is shown in a bypass position. In the bypass position the three-way throttle valve 18 is positioned to direct atmospheric air into the bypass portion 16. It is contemplated that substantially all of the atmospheric air within the intake air portion 12 will be directed into the bypass portion 16 when the three-way throttle valve 18 is in the bypass position. Atmospheric air within the bypass portion 16 draws exhaust gas from the EGR inlet 14 near the reduced width region 22 of the bypass portion 16. As mentioned above, the reduced width region 22 acts as a venturi such that a low pressure region forms at the minimum width of the reduced width region 22 and additional exhaust gas from the EGR inlet 14 may be drawn into the bypass portion 16 as the venturi increases the flow rate through the reduced width region 22.

Atmospheric air and exhaust gas from the EGR inlet 14 within the bypass portion 16 rejoin the intake air portion 12 at the second connection point 25 where the bypass portion 16 connects to the intake air portion 12 in the mixed atmospheric air and Combustion air portion 24 of the air intake system 10. The mixed atmospheric air and exhaust gas from the mixed atmospheric air and Combustion air portion 24 is adapted to be delivered to at least one cylinder of the engine for use in combustion.

It is contemplated that the three-way throttle valve 18 will be placed in the bypass position shown in FIG. 1b when the engine is operating under low speed and load conditions. Under such conditions the flow rate of atmospheric air within the intake air portion 12 may not be sufficient to allow sufficient quantities of exhaust gas from the EGR inlet 14. Thus, the use of the three-way throttle valve 18 to direct atmospheric air into the bypass portion 16 creates sufficient flow within the bypass portion for the EGR inlet 14 to deliver a quantity of exhaust gas required for desired engine operations and emissions compliance.

Referring next to FIG. 1c, the three-way throttle valve 18 is shown in a throttling position. In the throttling position the three-way throttle valve 18 is positioned to control the flow of atmospheric air in the intake air portion 12. It is contemplated that atmospheric air may pass through both the intake air portion 12 and the bypass portion 16 when the three-way throttle valve 18 is in the throttling position. Atmospheric air within the bypass portion 16 draws exhaust gas from the EGR inlet 14 near the reduced width region 22 of the bypass portion 16. However, exhaust gas from the EGR inlet 14 flows in the bypass portion 16 even without the presence of atmospheric air within the bypass portion 16.

Atmospheric air and exhaust gas from the EGR inlet 14 within the bypass portion 16 rejoin atmospheric air from the intake air portion 12 at the second connection point 25 where the bypass portion 16 connects to the intake air portion 12 in the mixed atmospheric air and Combustion air portion 24 of the air intake system 10. The mixed atmospheric air and exhaust gas from the mixed atmospheric air and Combustion air portion 24 is adapted to be delivered to at least one cylinder of the engine for use in combustion.

It is contemplated that the three-way throttle valve 18 will be placed in the throttling position shown in FIG. 1c under most engine operating conditions other than high speed and low speed operations where the three-way throttle valve 18 will typically be placed in the open position or the bypass position as shown in FIGS. 1a and 1b, respectively.

The three-way throttle valve 18 is adapted to be moved between the throttling position shown in FIG. 1c and the bypass position shown in FIG. 1b by rotation about the rotation axis 20. It may be noted that as shown in FIGS. 1a-1c, rotation in a counterclockwise direction from the fully open position moves the three-way throttle valve 18 to a throttling position, while rotation in a clockwise direction from the fully open position moves the three-way throttle valve 18 to the bypass position.

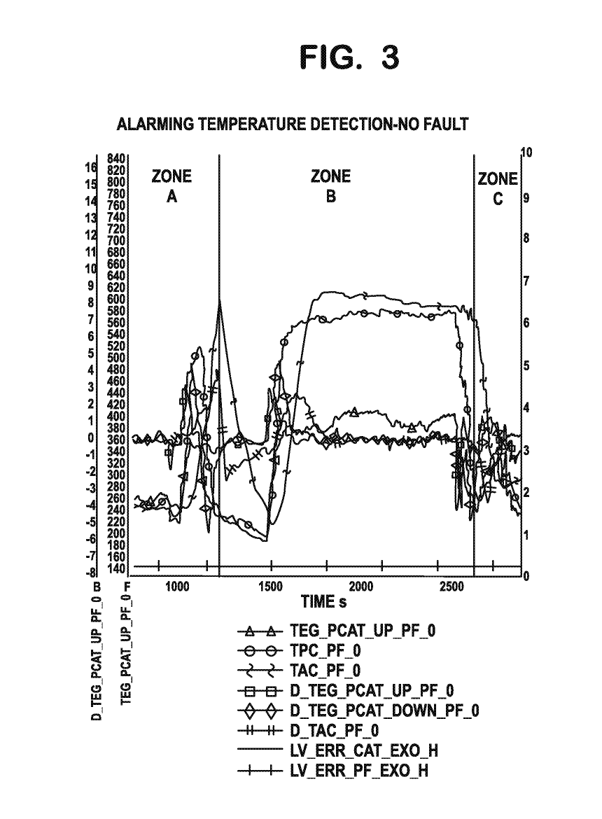

As may be observed in FIG. 2, the three-way throttle valve 18 has an elongate-shaped plate 26, the elongate-shape having a major axis and a minor axis. One contemplated elongate-shape for the plate 26 is an oval-shape. The rotation axis 20 passes through the minor axis of the elongate-shaped plate 26 of the three-way throttle valve 18. A shaft 28 is connected to the elongate-shaped plate 26 along the minor axis of the elongate-shaped plate 26. An actuator 30 connects to the shaft 28 disposed along the minor axis of the elongate-shaped plate 26 of the three-way throttle valve 18. The actuator 30 rotates the shaft 28, such that the three-way throttle valve 18 may be positioned between the bypass position and the throttling position shown in FIGS. 1b and 1c, respectively. The actuator 28 may also position the three-way throttle valve 18 at any position between the bypass position and the throttling position.

The three-way throttle valve 18 is adapted to be rotated from about 60° (sixty degrees) to about 120° (one-hundred twenty degrees) around the rotation axis 20. The amount of rotation around the rotation axis 20 will vary based on the difference in length of the major axis and the minor axis of the three-way throttle valve 18.

The three-way throttle valve 18 allows a single valve to be used to both throttle atmospheric air into an engine, and divert atmospheric air to a bypass portion 16 so that a sufficient amount of exhaust gas may be supplied by the EGR inlet 14 to allow the engine to function as intended under low speed operating conditions. The elongate-shape of the three-way throttle valve 18 therefore eliminates the requirement of a separate bypass valve from the air intake system 10.

What is claimed is:

1. A three-way throttle valve for an air intake system of an engine comprising:
an elongate-shaped valve plate disposed within an intake air portion of an air intake system, the elongate-shaped valve plate having a major axis and a minor axis;
a positioning shaft connected to the elongate-shaped valve plate, the positioning shaft being disposed about the minor axis of the elongate-shaped valve plate; and
an actuator connected to the positioning shaft, the actuator having at least a first position setting, a second position setting, and a third position setting;
wherein at least a portion of the elongate-shaped valve plate contacts a portion of the intake air portion of the air intake system when the actuator is disposed in the first position setting.

2. The three-way throttle valve for an air intake system of an engine of claim 1, wherein the first position setting is a bypass position.

3. The three-way throttle valve for an air intake system of an engine of claim 1, wherein the second position setting is a throttling position.

4. The three-way throttle valve for an air intake system of an engine of claim 1, wherein the third position setting is an open position.

5. The three-way throttle valve for an air intake system of an engine of claim 1, wherein the actuator first position setting is a bypass position, the second position setting is a throttling position, and wherein the actuator has a plurality of positional settings between the first position setting and the second position setting.

6. The three-way throttle valve for an air intake system of an engine of claim 1, wherein the elongate-shaped valve plate is oval-shaped.

7. The three-way throttle valve for an air intake system of an engine of claim 1, wherein the actuator is adapted to rotate about the minor axis in a first direction and a second direction, wherein the first direction corresponds to the first position, and the second direction corresponds to the second position.

8. The three-way throttle valve for an air intake system of an engine of claim 7, wherein the first position is a bypass position, and the second position is a throttling position.

9. An air intake system of an engine comprising:
an intake air portion having a first connection point and a second connection point;
a bypass portion connected to the intake air portion, the bypass portion connecting at the first connection point and the second connection point to the intake air portion, the bypass portion having a reduced width region;
an EGR inlet disposed within the bypass portion; and
a three-way throttle valve disposed within the intake air portion, the three-way throttle valve being moveable between at least a first position, a second position, and a third position, the first position of the three-way throttle valve directing fluid within the intake air portion to the bypass portion.

10. The air intake system of claim 9, wherein the reduced width region of the bypass portion forms a venturi.

11. The air intake system of claim 9, wherein the EGR inlet is disposed within the reduced width region of the bypass portion.

12. The air intake system of claim 9, wherein the three-way throttle valve further comprises:
an elongate-shaped valve plate disposed within an intake air portion of an air intake system, the elongate-shaped valve plate having a major axis and a minor axis;
a positioning shaft connected to the elongate-shaped valve plate, the positioning shaft being disposed about the minor axis of the elongate-shaped valve plate; and
an actuator connected to the positioning shaft, the actuator having at least a first position setting corresponding to the first position of the three-way throttle valve, a second position setting corresponding to the second position of the three-way throttle valve, and a third position setting corresponding to the third position of the three-way throttle valve.

13. The air intake system of claim 12, wherein the elongate-shaped valve plate is oval-shaped.

14. The air intake system of claim 12, wherein the actuator first position setting is a three-way valve bypass position, the second actuator position setting is three-way valve throttling position, and wherein the actuator has a plurality of position settings between the first position setting and the second position setting.

15. The air intake system of claim 14, wherein the bypass position arranges the elongate-shaped valve plate to block fluid flow within the intake air portion past the first connection point.

16. The air intake system of claim 12, wherein the actuator is adapted to rotate about the minor axis in a first direction and a second direction, wherein the first direction corresponds to the first actuator position, and the second direction corresponds to the second actuator position.

17. The air intake system of claim 9 further comprising a combustion air portion being disposed downstream of the second connection point.

18. A method of controlling fluid flow within an air intake system of an engine having an intake air portion, a bypass portion, an EGR inlet, and an elongate-shaped three-way valve, the method comprising:
receiving atmospheric air in an intake air portion of an air intake system;
rotating an elongate-shaped three-way valve disposed within the intake air portion to one of a first position, a second position, and a third position, the positioning of the elongate-shaped three-way valve directing the atmospheric air to at least one of the intake air portion and a bypass portion; and
receiving exhaust gas in the bypass portion from the EGR inlet.

19. The method of claim 18, wherein the rotating of the elongate-shaped three-way valve to the first position directs atmospheric air only to the bypass portion.

20. The method of claim 18, wherein the rotating of the elongate-shaped three-way valve a first direction positions the valve in the first position, while rotating of the elongate-shaped three-way valve a second direction positions the valve in the third position, wherein the first direction is opposite the second direction.
